(19) United States
(12) Patent Application Publication
(10) Pub. No.: US 2008/0095528 A1
(43) Pub. Date: Apr. 24, 2008

(54) PORTABLE ELECTRONIC DEVICE HAVING OPTIMIZED APERTURE

(75) Inventors: CHING-LUNG JAO, Chu-Nan (TW); CHIEN-CHIH LIU, Chu-Nan (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: ALTUS TECHNOLOGY INC., Chu-Nan (TW)

(21) Appl. No.: 11/617,059

(22) Filed: Dec. 28, 2006

(30) Foreign Application Priority Data
Oct. 18, 2006 (CN) 200610063160.6

(51) Int. Cl. G03B 9/00

(52) U.S. Cl. 396/458; 396/535

(57) ABSTRACT

A portable electronic device (200) includes a housing (20) and a digital camera module (30). The housing is configured for containing electronic components, and has an aperture (21) defined therethrough for allowing light to be transmitted therethrough. The aperture has a diameter which grows smaller from an outer side of the housing to an inner side of the housing. The digital camera module is mounted inside the inner side of the housing, and receives light transmitted from the aperture.

### BACKGROUND

1. Technical Field

The present invention generally relates to portable electronic devices and, more particularly, to a portable electronic device with a digital camera module.

2. Description of the Related Art

With the ongoing development of microcircuitry and multimedia technology, digital cameras are now in widespread use. High-end portable electronic devices such as mobile phones and PDAs (Personal Digital Assistants) are being developed to be increasingly multi-functional. Many of these portable electronic devices are now equipped with a digital camera.

FIG. 1 (related art) shows a portable electronic device 100 incorporating a typical digital camera module 10. The digital camera module 10 includes a lens module 12, an image pick up module 17 and a substrate 18. The lens module 12 has a barrel 13, a lens 14, and a transparent cover 15. The barrel 13 is a hollow cylinder in shape, and has a first end 131, and a second end 135 positioned opposite to the first end 131. The first end 131 of the barrel 13 is half closed, and has a stepped opening 133 defined therethrough. An annular stepped shielding surface 134 is formed correspondingly to the stepped opening 133. The lens 14 is received in the barrel 13. The transparent cover 15 is attached to the first end 131 of the barrel 13 to close the stepped opening 133. The image pick up module 17 is mounted on the substrate 17. The second end 135 of the barrel 13 is fixed to the substrate 18, and the lens module 10 is positioned to form a focused object image on the image pick up module 17.

The portable electronic device 100 also includes a housing 19 for receiving conventional electronic components. The housing 19 has a through hole 191 defined therethrough for allowing light to pass therethrough.

When the digital camera module 10 is integrated in the portable electronic device 100, the digital camera module 10 is received in the housing 19 and the through hole 191 of the housing 19 aligns with the stepped opening 133 of the lens module 12.

In the aforesaid digital camera module 10, the stepped opening 133 is configured for allowing sufficient image light to transmit therethrough whilst the annular stepped shielding surface 134 can block most or all stray/scattered light to reduce stray/glare and erroneous signals formed on the image pick up module 17. However, the first end 131 of the barrel 13 should have a certain thickness due to the special design of the stepped opening 133 and the annular stepped surface 134, which correspondingly increases the volume digital camera module 10. Accordingly, the portable electronic device 100 using the digital camera module 10 is relatively large in size and thus may be not fit the requirements for slim, compact and light construction.

Therefore, an improved portable electronic device is desired in order to overcome the above-described shortcomings.

### SUMMARY

In one aspect, a portable electronic device includes a housing and a digital camera module. The housing is configured for containing electronic components, and has an aperture defined therethrough for allowing light to be transmitted therethrough. The aperture has a diameter reduced from an outer side of the housing to an inner side of the housing. The digital camera module is mounted inside the inner side of the housing, and receives light transmitted from the aperture.

Other advantages and novel features will become more apparent from the following detailed description when taken in conjunction with the accompanying drawings.

### BRIEF DESCRIPTION OF THE DRAWINGS

Many aspects of the present portable electronic device can be better understood with reference to the following drawings. The components in the drawings are not necessarily drawn to scale, the emphasis instead being placed upon clearly illustrating the principles of the portable electronic device. Moreover, in the drawings, like reference numerals designate corresponding parts throughout the several views.

FIG. 1 is a cross-sectional view of a typical digital camera module installed in a portable electronic device; and

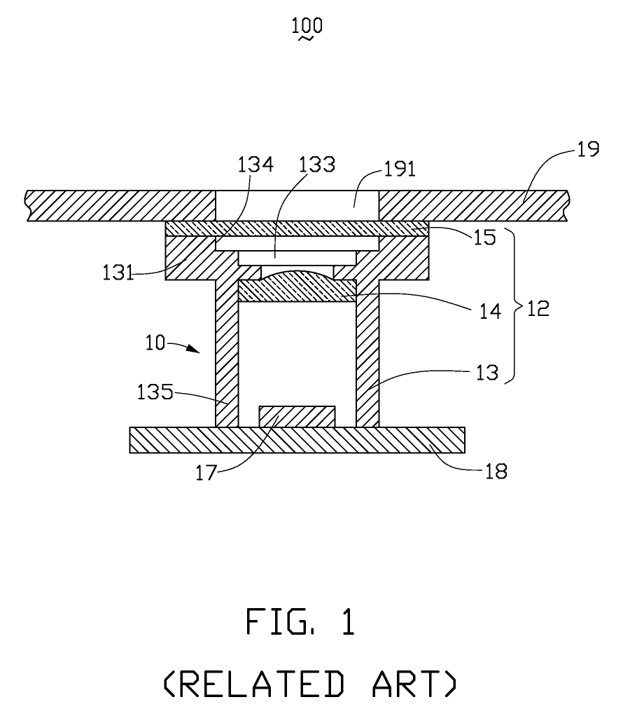

FIG. 2 is a schematic, cross-sectional view of a portable electronic device integrated with a digital camera module, according to a preferred embodiment of the present invention.

### DETAILED DESCRIPTION OF THE PREFERRED EMBODIMENT

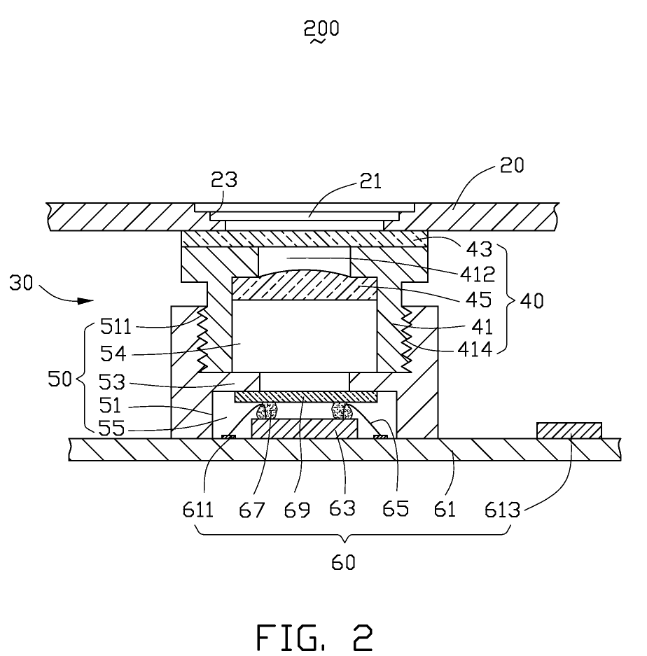

Referring to FIG. 2, a portable electronic device 200 according to a preferred embodiment of the present invention is shown. The portable electronic device 200 includes a housing 20 and a digital camera module 30 received in the housing 20.

The housing 20 is configured for accommodating conventional electronic components therein. The housing 20 has an optimized aperture 21 defined therethrough, and a shielding surface 23 conforming to the aperture 21. The aperture 21 has a diameter which shrinks from an outer side of the housing 20 to an inner side of the housing 20. The aperture 21 should preferably to have a stepped shape, as shown in the preferred embodiment. Alternatively, the aperture 21 can also be cone shaped. Accordingly, the shielding surface 23 can be stepped shaped or cone shaped with respect to the aperture 21. The aperture 21 is shaped to allow sufficient image light to pass therethrough, whilst the shielding surface 23 can block as much as possible stray/scatter light.

The digital camera module 30 includes a lens module 40, a holder 50 and a chip package 60, and the lens module 40 and the chip package 60 are mounted on two opposite ends of the holder 50.

The lens module 40 includes a lens barrel 41, a transparent cover 43, and at least one lens 45. The lens barrel 41 is a hollow cylinder in shape, and has a half closed end and a screwed end positioned opposite to the half closed end. The half closed end of the lens barrel 41 has an opening 412 defined in a middle portion thereof. The opening 412 has a uniform diameter. The screwed end of the lens barrel 41 has an external thread 414 formed thereon. The transparent cover 43 is mounted on the half closed end of the barrel 41, and encloses the opening 412 of the barrel 41, so as to allow light to enter into the barrel 41 and avoid dust particles entering into the barrel 41. The at least one lens 45 is received in the lens barrel 41 abutting the half closed end thereof, to receive image light transmitted from the through hole 412 of the lens barrel 41 and form a focused object image.

The holder 50 is a cylinder, and has a through hole penetrating therethrough. The holder 50 has an inner wall 51 surrounding the through hole, and an annular ring 53 radially projecting from the inner wall 51 of the holder 50. The annular ring 53 divides the through hole into a first cavity 54 for receiving the lens module 40 and a second cavity 55 for receiving the chip package 60. An internal thread 511 is formed on the inner wall 51, surrounding the first cavity 54, for screwable attachment with the external thread 414 of the lens barrel 41.

The chip package 60 includes a substrate 61, a chip 63, a plurality of wires 65, an adhesive 67, and a transparent lid 69. The substrate 61 has a plurality of contacts 611 arranged thereon, a connector 613 for connecting with other electronic components, and a plurality of conductive tracks (not shown) formed thereon to electrically connect the contacts 611 to the connector 613. The chip 63 can be, for example a complementary metal-oxide-semiconductor transistor (CMOS) image sensor, or a charge coupled device (CCD) image sensor, and is attached to the substrate 61, surrounded by the contacts 611. The chip 63 has an active area (not shown) and a plurality of pads (not shown) formed on a top surface thereof. Each wire 65 electrically connects a pad of the chip 63 to a corresponding contact 611 of the substrate 61. The adhesive 67 is applied on a periphery of the top surface of the chip 63, over the wires 65. In order to protect the wires from cracking due to external force, the adhesive 67 can be further applied around the chip 63 in a manner so as to cover the whole of each wire 65. The lid 69 is placed over the chip 63, and is adhered to the adhesive 37. The lid 69 and the adhesive 67 cooperatively enclose/seal the active area of the chip 63.

The lens module 40 is received in the first cavity 54 of the holder 50, and the external thread 414 of the lens barrel 41 engages with the internal thread 511 of the holder 41. The chip package 60 is mounted in the second cavity 55 of the holder 50, wherein an end of the holder 50 adjacent the second cavity 55 is attached to the substrate 61, and the annular ring 53 abuts against a periphery of a top surface of the lid 69 of the chip package 60. The active area of the chip 63 is located in the light path of the lens module 40.

The digital camera module 40 is received inside of the housing 20, with the transparent cover 43 contacting with the inner side of the housing 20. The aperture 21 of the housing 20 aligns with the opening 412 of the lens module 40.

In the aforesaid portable electronic device 200, the optimized aperture 21 is defined in the housing 20, and the housing 20 is of a thickness which is thick enough for defining the aperture 21. Thus, the digital camera module 40 can omit the optimized aperture and have a relatively small height thereof. Accordingly, the portable electronic device 200 using the relatively small digital camera module 200 may have a reduced volume.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A portable electronic device comprising:
a housing for containing electronic components, the housing having an aperture defined therethrough for allowing light to be transmitted therethrough, the aperture having a diameter reduced from an outer side of the housing to an inner side of the housing; and
a digital camera module mounted inside of the housing and contacting with the inner side of the housing, and receiving light transmitting from the aperture.

2. The portable electronic device as claimed in claim 1, wherein the aperture has a stepped shape.

3. The portable electronic device as claimed in claim 1, wherein the aperture is cone shaped.

4. The portable electronic device as claimed in claim 1, wherein the digital camera module comprises a lens module, and the lens module comprises a barrel, at least one lens received in the barrel and aligned with the aperture.

5. The portable electronic device as claimed in claim 4, wherein the lens barrel has an opening defined in a middle portion of one end, and the opening aligns with the aperture of the housing.

6. The portable electronic device as claimed in claim 5, wherein the lens module has a transparent cover, and the transparent cover is attached on the end of the lens barrel to close the opening.

7. The portable electronic device as claimed in claim 4, wherein the digital camera module further comprises a chip package disposed in a light path of the lens module.

8. The portable electronic device as claimed in claim 7, wherein the chip package comprises a substrate, a chip mounted to the substrate, and a cover disposed above the chip.

9. The portable electronic device as claimed in claim 7, wherein the digital camera module further comprises a holder to respectively receive the lens module and the chip package at two opposite ends thereof.

10. A portable electronic device comprising:
a housing configured for containing electronic components therein, the housing comprising a wall having an inner side and an opposite outer side, a through aperture being defined in the wall and extending through the inner side and the outer side for allowing light to be transmitted therethrough, a shielding surface formed around the aperture, the aperture having a diameter reduced from an outer side of the wall to an inner side of the wall so as to allow sufficient image light to pass therethrough whilst the shielding surface is capable of blocking stray/scatter light; and
a digital camera module mounted inside of the housing, the camera module comprising a holder, a barrel mounted in one end of the holder, and a chip package mounted in an opposite end of the holder, the barrel comprising a lens mounted therein, a transparent cover attached to the inner side of the wall for covering the lens, and an opening formed between the lens and the transparent cover, the chip package having a chip with an active area for receiving focused object image, wherein
the aperture, the opening, the lens and the active area are aligned.

11. The portable electronic device as claimed in claim 10, wherein the opening has a uniform diameter.

12. The portable electronic device as claimed in claim 10, wherein the holder comprises a first and second cavity formed at opposite ends thereof for respectively receiving the lens module and the chip package, an annular ring being formed between the first and second cavities.

13. The portable electronic device as claimed in claim 12, wherein the chip package further comprises a lid supported above the active area via adhersive, the lid contacting a surface of the annular ring adjacent the second cavity.
